(19) United States
(12) Patent Application Publication
(10) Pub. No.: US 2024/0112038 A1
(43) Pub. Date: Apr. 4, 2024

(54) CONTROLLING AGENTS USING REPORTER NEURAL NETWORKS

(71) Applicant: DeepMind Technologies Limited, London (GB)

(72) Inventors: Ishita Dasgupta, Brooklyn, NY (US); Shiqi Chen, New York, NY (US); Kenneth Daniel Marino, New York, NY (US); Wenling Shang, Hackensack, NJ (US); Arun Ahuja, London (GB)

(21) Appl. No.: 18/475,157

(22) Filed: Sep. 26, 2023

Related U.S. Application Data
(60) Provisional application No. 63/410,156, filed on Sep. 26, 2022.

(51) Int. Cl. G06N 3/091; G06F 40/35

(52) U.S. Cl. CPC G06N 3/091; G06F 40/35

(57) ABSTRACT

Methods, systems, and apparatus, including computer programs encoded on a computer storage medium, for controlling agents using reporter neural networks.

### CROSS-REFERENCE TO RELATED APPLICATION

This application claims priority to U.S. Provisional Application No. 63/410,156, filed on Sep. 26, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent interacting with an environment to perform a task in the environment.

In particular, the system controls the agent using an action selection neural network system that includes a policy neural network, a planner neural network, and a reporter neural network.

This specification also describes training the action selection neural network system and, in particular, the reporter neural network.

Particular embodiments of the subject matter described in this specification can be implemented so as to realize one or more of the following advantages.

This specification describes controlling an agent using a planner neural network that generates a natural language instruction and a policy neural network that receives the natural language instruction and a current observation and generates an output that defines an action to be performed by the agent.

For example, the planner neural network can be a pre-trained language model neural network, e.g., a large-scale language model neural network (LSLM).

Achieving complex tasks in a variety of different environments, e.g., in embodied environments, often requires logical reasoning. Such logical reasoning, e.g., about the relationships between objects in the environment, about properties of the environment or of objects in the environment, or about the impact of the agent's actions on the environment, has been a challenge for machine learning. Logical reasoning becomes even more of a challenge with embodied agents, where the agent also has to perceive and control objects or itself in its environment, in addition to reasoning about how to accomplish a complex task.

Recent language models, however, have shown great promise for reasoning. However, these models are not embodied or grounded. They do not have a way to directly take actions in embodied environments, or of knowing what is happening in an environment. Thus, directly using a language model neural network as the planner neural network has been shown to be difficult.

To address these issues, the described techniques make use of a reporter neural network that can generate a natural language report that characterizes the progress of the agent in performing the task and provide this natural language report as part of the input to the planner neural network. By giving the planner neural network access to this information, the system can effectively provide the planner neural network the context necessary to generate effective instructions to the policy neural network, thereby improving how well the policy neural network can control the agent to perform tasks. In other words, by incorporating the reporter neural network into the scheme for controlling the agent, the system improves how well the agent performs a wide variety of tasks, particularly if the task requires reasoning about aspects of the environment.

More specifically, because the planner neural network does not have the ability to interrogate the environment to observe the effects of the actions that the agent performs, the natural language reports that are generated by the reporter neural network provide relevant information about the environment that the planner neural network can use to adjust the instructions that are issued to the policy neural network (and, therefore, to the agent) and that would not have been available to the planner neural network otherwise.

Additionally, when the planner neural network is a pre-trained language model and the observations that are received are images of the environment or other sensor readings of the environment, the planner and the policy network do not operate over the same input spaces: the policy network receives observations, e.g., images or other sensor readings, and produces policy outputs that define actions, while the planner neural network receives natural language inputs (the task description and the natural language report) and produces natural language outputs (the produced natural language instruction). While the policy network is language conditional and can interpret the planner's instructions, the planner cannot parse the results of the actor's actions (to produce an appropriate next action) because the planner only operates on text inputs and not on, e.g., observations that characterize the state of the environment. To bridge this gap, the reporter neural network translates from the agent's action and observation space to the planner's input space by way of the natural language report generated using the reporter neural network.

Additionally, this specification describes techniques for training the reporter neural network, e.g., through reinforcement learning or imitation learning or both. In particular, the system can train the reporter neural network to learn what information is most helpful to the planner, and eventually converge to report only truthful and relevant information to the planner at any given time step. This eliminates the need to specify in advance which information will be relevant to the planner for any given task and allows the system to adapt and generalize to new tasks that require different types of information to be provided to the planner in order for the planner to effectively control the agent.

Generally, by incorporating the reporter neural network and the planner neural network into the loop into addition to the policy neural network, the resulting system can effectively perform any of a variety of tasks that require a combination of skills, e.g., two or more of the below examples. For example, the system can effectively perform tasks that require logical reasoning: the ability to take complex instructions and do different kinds of logical operations on them to determine the correct course of action. As another example, the system can effectively perform tasks that require generalization: the ability to generalize beyond the agent's previous experience. As another example, the system can effectively perform tasks that require exploration: the ability to explore the world around the agent to uncover new information that can inform its reasoning for what actions to take. As another example, the system can effectively perform tasks that require perception: The ability to use the raw observation the agent has (usually vision) and process the world and use what it sees to make decisions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a flow diagram of an example process for controlling an agent at a given time step.

FIG. 3 is a flow diagram of an example process for training the reporter neural network through reinforcement learning.

FIG. 4 shows an example of the operation of the action selection neural network system.

FIG. 5 shows an example of the improvements in agent control that are achieved by incorporating a planner neural network and a reporter that serves as a bridge between a policy neural network and the planner neural network.

Like reference numbers and designations in the various drawings indicate like elements.

### DETAILED DESCRIPTION

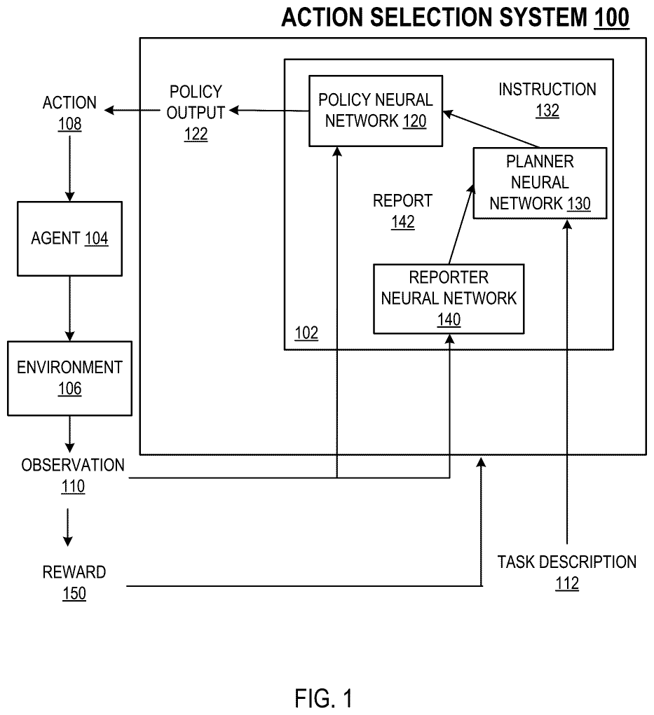

FIG. 1 shows an example action selection system 100. The action selection system 100 is an example of a system implemented as computer programs on one or more computers in one or more locations in which the systems, components, and techniques described below are implemented.

The action selection system 100 uses an action selection neural network system 102 to control an agent 104 interacting with an environment 106 to accomplish a task by selecting actions 108 to be performed by the agent 104 at each of multiple time steps during the performance of an episode of the task.

Examples of agents, environments, and tasks will be described below.

An “episode” of a task is a sequence of interactions during which the agent attempts to perform an instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

Prior to performing a task episode, the system 100 receives a task description 112 that defines the task that needs to be carried out during the task episode. In particular, the task description 112 is a natural language description of a task to be performed by the agent 104 in the environment 106. For example, the system 100 can receive the task description 112 as a text input or an audio input (that the system then converts to text) from a user.

Thus, an additional constraint on the task episode can be that the episode continues over a sequence of time steps until one of the above criteria are satisfied or until a new task description is received that specifies a new task to be performed (or modifies the existing task).

At each time step during any given task episode, the system 100 receives an observation 110 characterizing the current state of the environment 106 at the time step and, in response, selects an action 108 to be performed by the agent 104 at the time step.

The observation 110 can include any appropriate information that characterizes the state of the environment. As one example, the observation 110 can include sensor readings from one or more sensors configured to sense the environment. For example, the observation 110 can include one or more images captured by one or more cameras, measurements from one or more proprioceptive sensors, and so on.

After the agent performs the action 108, the environment 106 transitions into a new state.

In some cases, the system 100 receives a reward 150 from the environment in response to the agent performing the action.

Generally, the reward is a scalar numerical value and characterizes a progress of the agent towards completing the task.

As a particular example, the reward can be a sparse binary reward that is zero unless the task is successfully completed and one if the task is successfully completed as a result of the action performed.

As another particular example, the reward can be a dense reward that measures a progress of the agent towards completing the task as of individual observations received during the episode of attempting to perform the task, i.e., so that non-zero rewards can be and frequently are received before the task is successfully completed.

While performing any given task episode, the system 100 selects actions in order to attempt to maximize a return that is received over the course of the task episode.

That is, at each time step during the episode, the system 100 selects actions that attempt to maximize the return that will be received for the remainder of the task episode starting from the time step.

Generally, at any given time step, the return that will be received is a combination of the rewards that will be received at time steps that are after the given time step in the episode.

For example, at a time step t, the return can satisfy:

$${Σ}_{i} {γ}^{i - t - 1} {r}_{i} ,$$

where i ranges either over all of the time steps after t in the episode or for some fixed number of time steps after t within the episode, γ is a discount factor, and rᵢ is the reward at time step i.

As described above, the system 100 controls the agent 104 using an action selection neural network system 102.

The action selection system 102 includes a policy neural network 120, a planner neural network 130, and a reporter neural network 140.

The policy neural network 120 is a neural network that is configured to process as input an observation and a natural language instruction 132 to generate a policy output 122 that defines an action to be performed by the agent. The system 100 then uses the policy output 122 to select the action 108 to be performed by the agent 104.

The policy neural network 120 can have any appropriate architecture that allows the policy neural network 120 to map an observation and a natural language instruction to a policy output.

For example, the policy neural network 120 can include one encoder for the observation, another encoder for the natural language instruction, and a policy subnetwork configured to process the outputs from the two encoders to generate the policy output. In some cases, the policy subnetwork can include a memory neural network, e.g., a recurrent neural network or a Transformer neural network, so that the policy output 122 at a given time step incorporates information from previous time steps.

As a particular example, when the neural network 120 receives visual observations, e.g., images or videos, the neural network can have a convolutional visual encoder to encode visual observations, and a recurrent neural network, e.g., LSTM-based, language encoder to encode action instructions. The neural network can also have a LSTM-based memory module to help take previous actions and observations into account for policy outputs.

In one example, the policy output 122 may include a respective Q-value for each action in a fixed set. The system 100 can process the Q-values (e.g., using a soft-max function) to generate a respective probability value for each action, which can be used to select the action or can select the action with the highest Q-value.

The Q value for an action is an estimate of a “return” that would result from the agent performing the action in response to the current observation and thereafter being controlled using actions generated by the action selection system.

In another example, the policy output 122 may include a respective numerical probability value for each action in the fixed set. The system 100 can select the action, e.g., by sampling an action in accordance with the probability values, by selecting the action with the highest probability value.

As another example, when the action space is continuous the policy output 122 can include parameters of a probability distribution over the continuous action space. The system 100 can then select an action by sampling an action from the probability distribution or by selecting the mean action.

The planner neural network 130 is a neural network that is configured to process a planner input to generate, as output, a natural language instruction 132 for the policy neural network 120.

Generally, the planner input includes the task description 112 and a natural language report 142 that, as will be described in more detail below, describes the current state of the task episode. That is, the natural language report 142 at a given time step during a task episode characterizes the progress of the agent in completing the task as of the given time step.

The natural language instruction can be considered to be a “planning” output that provides to the policy neural network 122 high-level information that is useful in performing the task, i.e., that guides the policy neural network 120 to select an appropriate “low-level” action for controlling the agent.

For example, the planner neural network 130 can be a language model neural network that has been trained on a language modeling objective. That is, the language model neural network can have been pre-trained on the language modeling objective on a large corpus of training data. In some implementations, the planner neural network 130 has not been trained to control agents, i.e., has not been trained jointly with either the policy neural network 120 or the reporter neural network 140.

A language model neural network is a neural network that is configured to process an input to generate an output that includes a probability distribution over a set of text tokens in vocabulary of text tokens, with the probability for each token representing the likelihood that the text token immediately follows the input.

For example, the language model neural network can be an auto-regressive language model neural network.

The language model neural network is referred to as an auto-regressive neural network because the neural network auto-regressively generates an output sequence of tokens by generating each particular token in the output sequence conditioned on a current input sequence that includes any tokens that precede the particular text token in the output sequence, i.e., the tokens that have for already been generated for any previous positions in the output sequence that precede the particular position of the particular token, and a context input that provides context for the output sequence (a “context sequence”).

For example, the current input sequence when generating a token at any given position in the output sequence can include the context sequence and the tokens at any preceding positions that precede the given position in the output sequence. As a particular example, the current input sequence can include the context sequence followed by the tokens at any preceding positions that precede the given position in the output sequence. Optionally, the context and the current output sequence can be separated by one or more predetermined tokens within the current input sequence.

More specifically, to generate a particular token at a particular position within a candidate output sequence, the neural network can process the current input sequence to generate a score distribution, e.g., a probability distribution, that assigns a respective score, e.g., a respective probability, to each text token in the vocabulary of text tokens. The neural network 110 can then select, as the particular token, a text token from the vocabulary using the score distribution. For example, the neural network can greedily select the highest-scoring token or can sample, e.g., using nucleus sampling or another sampling technique, a token from the distribution.

As a particular example, the language model neural network can be an auto-regressive Transformer-based neural network that includes (i) a plurality of attention blocks that each apply a self-attention operation and (ii) an output subnetwork that processes an output of the last attention block to generate the score distribution.

The neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoory Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates at least the hidden state for the last token in given input sequence at least in part by applying self-attention to generate a respective output hidden state for the last token. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

As described, prior to using the language model neural network as the planner neural network 130, the system 100 or another training system pre-trains the language model neural network on a language modeling task, e.g., a task that requires predicting, given a current sequence of text tokens, the next token that follows the current sequence in the training data. As a particular example, the language model neural network can be pre-trained on a maximum-likelihood objective on a large dataset that includes text, e.g., text that is publicly available from the Internet or another text corpus.

For example, the reporter neural network 130 can be a pre-trained large-scale language model (LSLM). An example, the LSLTM can be one of two variants of the Chinchilla models described in Hoffmann, et al, linked above: one with 70 billion parameters (referred as the 70B model), and one with 7 billion parameters (referred as the 7B model).

In this example, after the first time step in the task episode, the planner input can also include the reporter inputs at one or more preceding time steps and the natural language instructions generated at the one or more preceding time steps. Including these preceding outputs can provide the planner neural network 130 with context for generating the appropriate natural language instruction at the current time step.

In this example, the planner input can also include one or more prompt inputs that give the planner access to examples of “ground truth” agent control in response to example task descriptions. That is, the planner input can include a k-shot prompt, where k is an integer greater than equal to one, that includes k prompt inputs. For example, each planner input can include an example task description; one or more example reporter inputs; and for each reporter input, an example natural language report generated in response to the reporter input. Including the k-shot prompt can assist the planner neural network 130 in performing “in-context learning” to adapt to generating appropriate natural language instructions.

The reporter neural network 140 is a neural network that is configured to process a reporter input that includes an observation to generate a reporter output that defines the natural language report 142, i.e., the report 142 that characterizes the progress of the agent in completing the task as of the time step.

In some implementations, the reporter output is the natural language report 142. That is, the reporter neural network 140 is a generative neural network that processes an observation to generate a natural language output.

For example, the reporter neural network 140 can have any appropriate visual language model (VLM) neural network architecture. A visual language model (VLM) is a neural network that receives images and, optionally, text as input and generates text as output. For example, the VLM can include an encoder neural network, e.g., a Vision Transformer or a convolutional neural network, that processes an image to generate an encoded representation of the image and a decoder neural network, e.g., a Transformer-based decoder neural network, that generates the text conditioned on the encoded representation of the image and, optionally, embeddings of the input text. One example of a VLM is the Flamingo model described in Flamingo: a Visual Language Model for Few-Shot Learning, available at arXiv:2204.14198. Another example of a VLM is described in Multimodal Few-Shot Learning with Frozen Language Models, available at arXiv:2106.13884.

In some other implementations, the reporter output can be a classification output over a plurality of categories, e.g., a plurality of categories that each represent a different level of progress in completing the task. As one example, when the task is to navigate to a specified location, each category can represent a different range of distance between the agent and the specified location. As another example, when the task is to locate an object with a specified property, each category can represent a different property of the closest object in the environment to the agent. In these implementations, the system 102 can generate the report 142 by selecting a category from the plurality of categories using the classification output, e.g., by sampling from the classification output or by selecting the category with the highest score according to the classification output, and generating the natural language report by inserting, at a predetermined location in the natural language report, a natural language description of the selected category.

In these implementations, the reporter neural network 140 can have any appropriate architecture that allows the neural network to map an observation to a classification output, e.g., a convolutional neural network, a fully-connected neural network, or a self-attention-based neural network.

For example, when the observation includes an image, the reporter neural network 140 can include a first encoder sub-network that encodes the image, e.g., a vision Transformer or a convolutional neural network.

In some implementations, one or more of the encoder neural networks have been pre-trained, e.g., as part of a classification neural network or on a representation learning task. As particular example, when the observation includes an image of the environment and the reporter neural network includes a first encoder neural network configured to process the image, the first encoder can have been pre-trained on a visual representation learning task.

As another example, when the reporter input includes a natural language instruction from one or more preceding time steps (i.e., in addition to the observation), the reporter neural network can include a second encoder neural network configured to process the natural language instruction(s) to encode the instruction(s). In some of these cases, the second encoder can have been pre-trained on a text representation learning task.

Using pre-trained encoders can allow the system 100 to leverage representations learned on large-scale data that can lead to accurate reports being generated by the reporter neural network.

In some implementations, the policy neural network 120 and the reporter neural network 140 each receive the same type of observation, i.e., each receive the observation 110.

In some other implementations, the policy neural network 120 and the reporter neural network 140 receive different types of observations that contain different information about the environment. For example, when the observation 110 includes data generated by multiple sensors, the policy neural network 120 can receive a second observation that includes data from a second subset of the sensors while the reporter neural network 140 receive a first observation that includes data from a first subset of the sensors.

In some implementations, the reporter neural network 140 can include a memory subnetwork, e.g., a recurrent neural network or a Transformer neural network, so that the reporter neural network 140 can incorporate context from previous time steps.

In some implementations, the reporter input also includes additional information in addition to the observation, e.g., the action performed at one or more preceding time steps.

Generally, at any given time step during a task episode, the system 100 uses the reporter neural network 140 and the planner neural network 130 to generate an input to the policy neural network 120 and then uses the policy output 122 generated by the policy neural network 120 to select the action 108 to be performed by the agent 104 at the time step.

The system 100 then causes the agent 104 to perform the selected action 108.

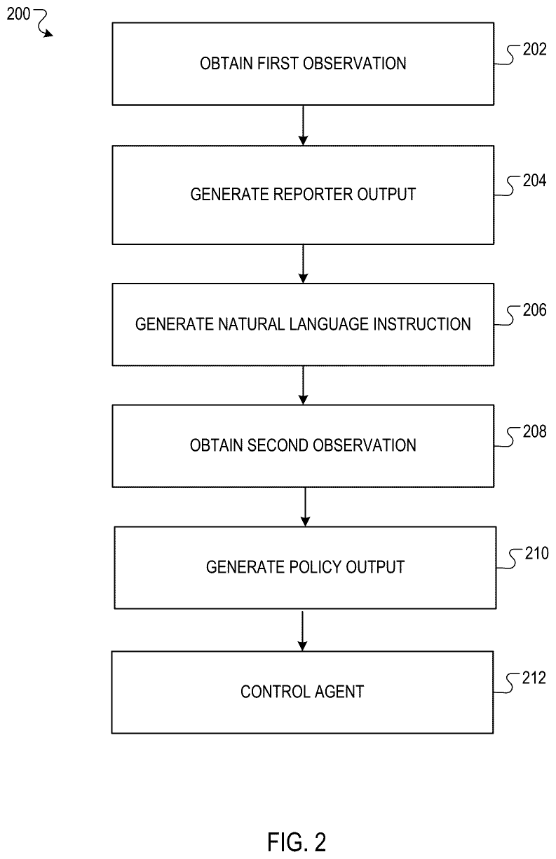

This will be described in more detail below with reference to FIG. 2.

FIG. 2 is a flow diagram of an example process 200 for controlling the agent at a given time step during a task episode. For convenience, the process 200 will be described as being performed by a system of one or more computers located in one or more locations. For example, an action selection system, e.g., the action selection system 100 of FIG. 1, appropriately programmed in accordance with this specification, can perform the process 200.

The system obtains a first observation characterizing a state of the environment at the time step (step 202).

The system processes a reporter input that includes the first observation using the reporter neural network to generate a reporter output (step 204).

Generally, the reporter output defines a natural language report that characterizes a progress of the agent in completing the task as of the time step.

In some cases, the reporter input can also include additional information, e.g., the task description, a natural language instruction that was provided to the agent at the preceding time step, the action performed at one or more preceding time steps, and so on.

The system processes a planner input that includes the task description and the natural language report using the planner neural network to generate a natural language instruction for the agent (step 206).

The system obtains a second observation characterizing the state of the environment at the time step (step 208).

In some cases, the first and second observations are the same. For example, both can include information generated from sensor readings generated by the same set of one or more sensors that sense the environment at the time step.

In some other cases, the first and second observations can include different information. For example, the first and second observations can include information generated from sensor readings generated by different combinations of sensors that sense the environment at the time step.

The system processes the natural language instruction and the second observation using a policy neural network to generate a policy output (step 210). As described above, the policy output defines an action to be performed by the agent.

The system controls the agent using the policy output (step 212), i.e., by selecting an action using the policy output and causing the agent to perform the selected action.

As described above, as a result of the agent performing the selected action, the environment generally changes state and the system receives a next observation for the next time step that characterizes the new state of the environment.

The system can then use the next observation and the reporter neural network to generate a new natural language report for the next time step.

Optionally, the system can then receive a reward indicating the progress of the agent in completing the task.

Thus, because the planner neural network does not have the ability to interrogate the environment to observe the effects of the actions that the agent performs, the natural language reports that are generated by the reporter neural network provide relevant information about the environment that the planner neural network can use to adjust the instructions that are issued to the policy neural network (and, therefore, to the agent).

Additionally, when the planner neural network is a pre-trained language model and the observations that are received are images of the environment or other sensor readings of the environment, the planner and the policy network do not operate over the same observation spaces: the policy network operates over pixel observations (or other sensor readings) and produces actions, while the planner operates over a language observation (the prompt) and produces language actions (the produced instruction).

While the policy network is language conditional and can interpret the planner's instructions, the planner cannot parse the results of the actor's actions (to produce an appropriate next action). Thus, the reporter translates from the actor's action and observation space to the planner's.

In some implementations, the planner and the reporter execute at less than all of the time steps in a given task episode. For example, the planner and the reporter can execute at every n time steps, where n is a fixed integer greater than one. In these implementations, the policy neural network can continue to receive the same natural language instruction at different time steps until a new natural language instruction is generated by the planner.

When the system receives a reward in response to performing the action, the system can use the received reward to train the reporter neural network through reinforcement learning, i.e., to maximize expected returns received in response to actions performed by the agent.

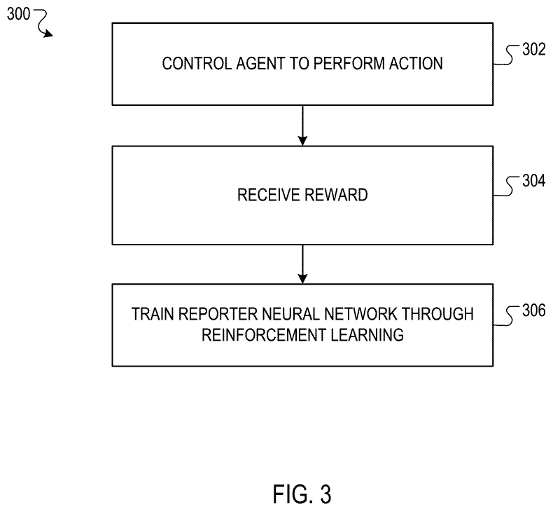

This is described in FIG. 3.

FIG. 3 is a flow diagram of an example process 300 for training the reporter neural network. For convenience, the process 300 will be described as being performed by a system of one or more computers located in one or more locations. For example, an action selection system, e.g., the action selection system 100 of FIG. 1, appropriately programmed in accordance with this specification, can perform the process 300.

The system controls the agent to perform an action using the reporter neural network, the policy neural network, and the planner neural network (step 302), e.g., as described above with reference to FIG. 2.

The system receives a reward as a result of the agent performing the action (step 304).

The system trains the reporter neural network using the reward through reinforcement learning (step 306).

For example, the system can store a transition that includes the observation, the task description, the natural language report, and the reward in a replay memory. The system can then repeatedly sample transitions or sequences of transitions from the replay memory and use the sampled transitions to train the reporter neural network through reinforcement learning.

The system can use any appropriate reinforcement learning training technique for training the reporter neural network. Examples of reinforcement learning techniques that can be used include V-Trace, PPO, MPO, and so on.

As a particular example, the system can train the reporter neural network while holding the planner neural network and the policy neural network fixed. In this example, although the reward was received as a result of the agent being controlled using a policy output, the system does not use the reward to train the policy neural network, but instead only uses the reward to train the reporter neural network, which generated a natural language report that only “indirectly” the selection of the action (and, therefore, the reward) by changing how the planner neural network is conditioned.

In particular, the planner neural network and the policy neural network can have been pre-trained on respective objectives and the system can hold the parameters of the planner and policy neural networks fixed to the values generated as a result of this pre-training.

For example, the policy neural network can have been trained through reinforcement learning or on imitation learning on one or more different tasks than the one specified by the task description. For example, the policy neural network can have been trained using task descriptions that are generated by users or by a different planner neural network. Additionally, as described above, the planner neural network can have been pre-trained on a language modeling task, and can be held fixed during the reporter training (and was not used during the policy neural network training).

Thus, as reinforcement learning training of the reporter neural network continues, the system can use the rewards, e.g., the final reward of the episode for sparse reward tasks, to reinforcement learn what information is most helpful to the planner neural network, with the training of the reporter eventually converging to report only truthful and relevant information to the planner at any given time step. This eliminates the need to specify in advance which information will be relevant to the planner for any given task and allows the system to adapt and generalize to new tasks that require different types of information to be provided to the planner in order for the planner to effectively control the agent.

In some cases, instead of or in addition to training the reporter neural network through reinforcement learning, the system can have access to a set of demonstration data that includes sequences of observation-action pairs characterizing interaction of an expert agent with the environment to perform a corresponding task and, for each corresponding task, a natural language description of the task. The system can then train the reporter neural network on this demonstration data through imitation learning, e.g., through behavior cloning or adversarial imitation learning.

Additionally, as described above, the reporter neural network can, in some implementations, have one or more encoders that have been pre-trained on other tasks. In these implementations, the system can either (i) hold these encoders fixed during the above training of the reporter neural network and only train the remainder of the reporter neural network or (ii) fine-tune the pre-trained encoders along with the remainder of the reporter neural network.

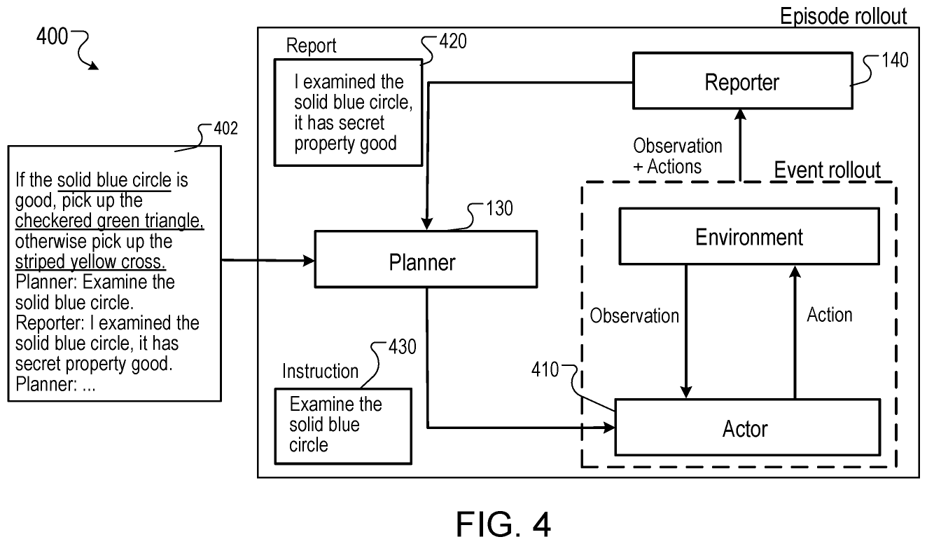

FIG. 4 shows an example 400 of the operation of the system when controlling an agent to perform a task episode.

In the simplified example of FIG. 4, the task requires information gathering. The goal of the episode is to pick up a correct object, based on another object's secret property. The task description passed to the planner neural network is as follows: ‘If {decider object} is good, pick up {object 1}, otherwise pick up {object 2}’.

To successfully complete an episode of this task, five high-level steps are required to be performed: a) the Planner instructs the Actor to examine the {decider object}, b) the Actor examines the object, c) the Reporter relays the revealed information, d) the Planner reasons which object needs to be picked up based on the report, {object 1} or {object 2}, and instructs the Actor to pick up the correct object e) the Actor picks up the correct object.

In the example of FIG. 4, the “solid blue circle” is the decider object and the checkered green triangle is object 1 while the striped yellow cross is object 2. Thus, in the example of FIG. 4, the task description 402 for the episode is ‘If solid blue circle is good, pick up the checkered green triangle, otherwise pick up the striped yellow cross’.

To control the agent, an actor 410 implements an instance of the policy neural network and uses the policy neural network to act in the environment in response to received observations. At a given time step, the system uses the reporter neural network 140 to generate a natural language report 420 that reads “I examined the solid blue circle, it has secret property good.”

The system provides this report 420 along with the task description 402 to the planner neural network 130, which generates a natural language instruction 430 to have the agent “examine the blue circle.”

The system provides the natural language instruction 430 to the actor 410, which uses the instruction 430 and the observation to generate an input to the policy neural network 120.

Thus, the report 430 provides information to the planner neural network 130 about the progress of the agent in performing the task, e.g., about which objects the agent has examined thus far and what their properties are. The planner neural network 130 can then leverage this information to update the instruction that is provided to the agent to cause the agent to examiner relevant objects in order to successfully complete the task.

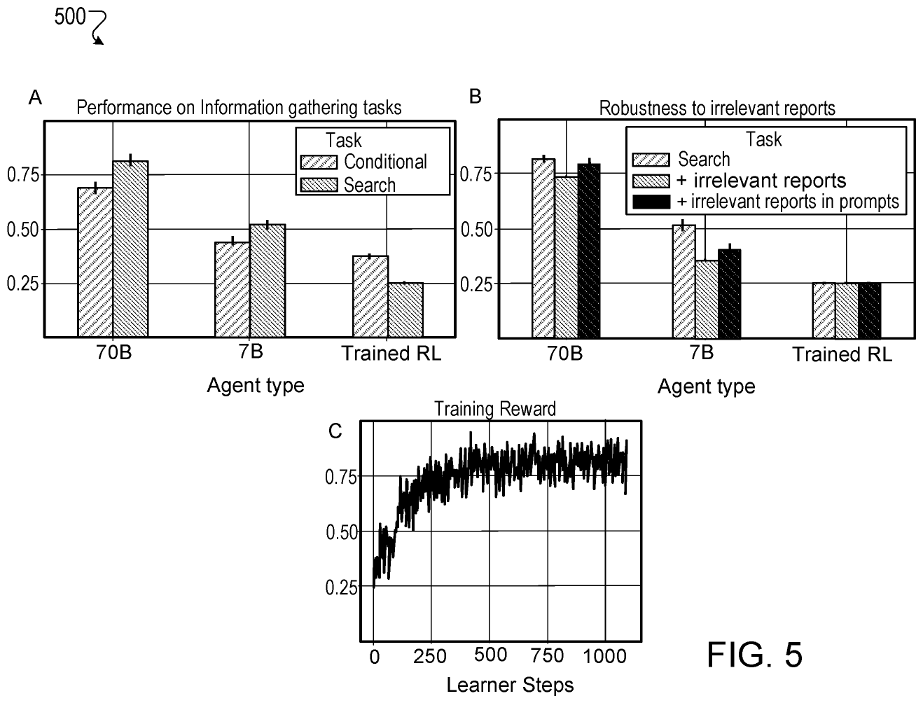

FIG. 5 shows an example 500 of the improvements in agent control that are achieved by incorporating a planner neural network and a reporter that serves as a bridge between a policy neural network and the planner neural network.

In particular, part A of FIG. 5 shows the performance on information gathering tasks with a) 7B parameter planner neural network, b) a 70B parameter planner neural network, and c) a “trained RL baseline” that does not use the reporter neural network or the planner neural network but directly provides a “report” like the one that would be generated by the reporter neural network to the policy neural network.

In particular, the example of FIG. 5 shows the performance on a “conditional” information gathering task like the one described above and a “search” information gathering task. The “search” task extends the “conditional” task by requiring additional steps of information gathering. Instead of examining a single object, the agent needs to examine multiple objects, note their secret properties, and pick up the correct object for reward. For example, the task description can be specified as ‘The objects are {}, {}, {}, and {}. Pick up the object with the good secret property’. A successful episode consists of the Planner asking the Actor to examine each object in turn until it finds one with a ‘good’ property, at which point it asks the Actor to pick up that object.

As can be seen from part A of FIG. 5, both the 7B parameter and 70B parameter planners outperform the “trained RL” baseline on both tasks, with the 70B parameter planner (and the corresponding increase in reasoning ability encoded within the parameters of the larger planner neural network) significantly outperforming the baseline.

As can be seen from the baseline, both of these are difficult tasks for the reinforcement learning baseline, even with the policy neural network being provided a “report” as an additional input.

In some cases, the reporter may provide “noisy” information to the planner. That is, because of the variable nature of the tasks and because accurately describing the progress of the agent is a difficult task, the natural language reports may at times be erroneous or irrelevant to planning.

Part B of FIG. 5 shows the robustness to irrelevant reports of the 7B, 70B, and baseline variants, e.g., where the reports are forced to describe irrelevant actions 20% of the time. As shown in Part B, both the 7B and 70B variants outperform the baseline in the presence of irrelevant reports. Moreover, when the k-short prompt to the planner describes how to handle irrelevant reports, performance rebounds to almost the original level (where irrelevant reports are reduced).

Part C shows the increase in training reward that is achieved as the reporter neural network is trained on a visual conditional task while holding the planner and the policy neural networks fixed. As can be seen from Part C, training the reporter neural network significantly improves the performance of the policy neural network in controlling the agent.

One example of a visual conditional task is a task where the target object changes depending on the color of the agent. This agent color information is not available to the language model, i.e., the planner. The reporter must therefore learn to decode it from visual observations, and report it back. The language model can then issue the right next instruction, which leads to reward.

A more complex example of a visual conditional task that combines the challenges of multistep tasks with learning to report is a task where the agent has to do an information gathering action in order to get the relevant information. For example, which object the agent must pick up can depend on whether a designated decider object is close to a wall or other location in the environment. In order to gauge this, the agent has to navigate to the object to examine its surroundings.

As described above, including the reporter neural network can improve the operation of the system in a variety of ways. This can be the case even when the reporter provides noisy information to the planner.

Some examples of this are shown in Table 1 below, where outputs of the reporter are denoted as Actor and the outputs of the planner are denoted as LM. The first box highlights a mistake made the by the reporter, and the second box shows how the planner causes the policy neural network and the planner to repeat the report, resulting in the mistake being corrected.

In some cases, the planner neural network can, e.g., by way of the k-shot prompt, be caused to repeat instructions in an attempt to cause the reporter to provide relevant information instead of irrelevant or noisy information. This is shown in Table 2 below.

TABLE 2
QUESTION: The objects in the room are noisy dark red tee,
vertical striped cyan plus, noisy purple u and horizontal
striped pink triangle. Get the object with a good secret property.
ANSWER:
LM: Examine noisy dark red tee.<EOS>
Agent: I have moved up and right.<EOS>
LM: Examine noisy dark red tee.<EOS>
Agent : I have moved up and right.<EOS>
LM: Examine noisy dark red tee.<EOS>
Agent: I have moved down and right.<EOS>
LM: Examine noisy dark red tee.<EOS>
Agent: I have moved down and left.<EOS>
LM: Examine noisy dark red tee.<EOS>
Agent: I examined noisy dark red tee.
Its secret property has value bad.<EOS>
LM: Examine vertical stiped cyan plus.<EOS>
Agent: I have moved left.<EOS>
LM: Examine vertical striped cyan plus.<EOS>
Agent: I examined vertical striped cyan plus.
Its secret property has value good.<EOS>
LM: Pickup vertical striped cyan plus.<EOS>

In some implementations, the planner can cycle through commands, e.g., to examine various objects, until it receives a report of a good object, as shown in Table 3 below:

TABLE 3
QUESTION: The objects in the room are grid pink tee, horizontal
striped yellow upside down tee, vertical striped light
yellow h and noisy dark blue upside down u. Get the object
with a good secret property.
ANSWER:
LM: Examine grid pink tee.<EOS>
Agent: I have moved up.<EOS>
LM: Examine horizontal striped yellow upside down tee.<EOS>
Agent: I have moved up and right.<EOS>
LM: Examine vertical striped light yellow h.<EOS>
Agent: I have moved down and left.<EOS>
LM: Examine noisy dark blue upside down u.<EOS>
Agent: I examined noisy dark blue upside down u.
Its secret property has value bad.<EOS>
LM: Examine grid pink tee.<EOS>
Agent: I have moved down and left.<EOS>
LM: Examine horizontal striped yellow upside down tee.<EOS>
Agent: I have moved down.<EOS>
LM: Examine vertical striped light yellow h.<EOS>
Agent: I have moved down.<EOS>
LM: Examine noisy dark blue upside down u.<EOS>
Agent: I examined vertical striped light yellow u.
Its secret property has value bad.<EOS>
LM: Examine grid pink tee.<EOS>
Agent: I have moved up and right.<EOS>
LM: Examine horizontal striped yellow upside down tee.<EOS>
Agent: I examined grid pink tee.
Its secret property has value good.<EOS>
LM: Pickup grid pink tee.<EOS>

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement, e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use of a resource the metric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment such as a heater, a cooler, a humidifier, or other hardware that modifies a property of air in the real-world environment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that indirectly performs or controls the protein folding actions, e.g., by controlling chemical synthesis steps selected by the system automatically without human interaction. The observations may comprise direct or indirect observations of a state of the protein or chemical/intermediates/ precursors and/or may be derived from simulation. Thus, the system may be used to automatically synthesize a protein with a particular function such as having a binding site shape, e.g., a ligand that binds with sufficient affinity for a biological effect that it can be used as a drug. For example, e.g., it may be an agonist or antagonist of a receptor or enzyme; or it may be an antibody configured to bind to an antibody target such as a virus coat protein, or a protein expressed on a cancer cell, e.g., to act as an agonist for a particular receptor or to prevent binding of another ligand and hence prevent activation of a relevant biological pathway.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

Aspects of the present disclosure may be as set out in the following clauses:

What is claimed is:

1. A method performed by one or more computers, the method comprising:
receiving a task description, wherein the task description is a natural language description of a task to be performed by an agent in an environment; and
controlling the agent across a sequence of time steps to cause the agent to perform the task, comprising, at each of a plurality of time steps in the sequence:
obtaining a first observation characterizing a state of the environment at the time step;
processing a reporter input comprising the first observation using a reporter neural network to generate a reporter output that defines a natural language report that characterizes a progress of the agent in completing the task as of the time step;
processing a planner input that comprises the task description and the natural language report using a planner neural network to generate a natural language instruction for the agent;
obtaining a second observation characterizing a state of the environment at the time step;
processing the natural language instruction and the second observation using a policy neural network to generate a policy output that defines an action to be performed by the agent;
selecting an action using the policy output; and
causing the agent to perform the selected action.

2. The method of claim 1, wherein the planner neural network has been pre-trained through unsupervised learning on a language modeling objective.

3. The method of claim 2, wherein the planner input further comprises one or more prompt inputs that each comprise:
an example task description;
one or more example reporter inputs; and
for each reporter input, an example natural language report generated in response to the reporter input.

4. The method of claim 2, wherein the reporter output is the natural language report.

5. The method of claim 2, wherein the reporter output comprises a classification output over a plurality of categories.

6. The method of claim 5, further comprising:
selecting a category from the plurality of categories using the classification output; and
generating the natural language report, comprising, inserting, at a predetermined location in the natural language report, a natural language description of the selected category.

7. The method of claim 1, further comprising:
receiving a reward for the task in response to the agent performing the selected action; and
using the received reward to train the reporter neural network through reinforcement learning.

8. The method of claim 7, wherein using the received reward to train the reporter neural network through reinforcement learning comprises:
training the reporter neural network without training the policy neural network.

9. The method of claim 8, wherein the policy neural network has been trained on a different task from the task described by the task description.

10. The method of claim 7, wherein the reporter neural network comprises one or more encoder neural networks that have been pre-trained.

11. The method of claim 10, wherein the first observation comprises an image of the environment, wherein the reporter neural network comprises a first encoder neural network configured to process the image and that has been pre-trained on a visual representation learning task.

12. The method of claim 10, wherein the reporter input further comprises a natural language instruction from a preceding time step, and wherein the reporter neural network comprises a second encoder neural network configured to process the natural language instruction and that has been pre-trained on a text representation learning task.

13. The method of claim 10, wherein the reporter neural network comprises an output subnetwork configured to receive a respective output from each of the encoder neural networks and to generate the reporter output from the respective outputs, and wherein training the reporter neural network comprises:
training the output subnetwork through reinforcement learning while holding the pre-trained encoders fixed; or
training the output subnetwork and the pre-trained encoders through reinforcement learning.

14. The method of claim 1, wherein the first observation is the same as the second observation.

15. The method of claim 1, wherein the agent is a mechanical agent and the environment is a real-world environment.

16. The method of claim 15, wherein the mechanical agent is a robot.

17. The method of claim 15, wherein the first and second observations include data generated from sensor readings captured by one or more sensors of the mechanical agent.

18. The method of claim 1, wherein obtaining the task description comprises:
obtaining the task description as a text input or as a spoken input from a user.

19. The method of claim 1, wherein the planner input further comprises one or more natural language reports from one or more preceding time steps in the sequence.

20. The method of claim 1, further comprising:
obtaining demonstration data, the demonstration data comprising a natural language description of an example task and data characterizing performance of the example task by an expert agent; and
training the reporter neural network through imitation learning on the demonstration data.

21. The method of claim 20, wherein training the reporter neural network through imitation learning on the demonstration data comprises:
training the reporter neural network on the demonstration data while holding the policy neural network and the planner neural network fixed.

22. A system comprising:
one or more computers; and
one or more storage devices communicatively coupled to the one or more computers, wherein the one or more storage devices store instructions that, when executed by the one or more computers, cause the one or more computers to perform operations comprising:
receiving a task description, wherein the task description is a natural language description of a task to be performed by an agent in an environment; and
controlling the agent across a sequence of time steps to cause the agent to perform the task, comprising, at each of a plurality of time steps in the sequence:
obtaining a first observation characterizing a state of the environment at the time step;
processing a reporter input comprising the first observation using a reporter neural network to generate a reporter output that defines a natural language report that characterizes a progress of the agent in completing the task as of the time step;
processing a planner input that comprises the task description and the natural language report using a planner neural network to generate a natural language instruction for the agent;
obtaining a second observation characterizing a state of the environment at the time step;
processing the natural language instruction and the second observation using a policy neural network to generate a policy output that defines an action to be performed by the agent;
selecting an action using the policy output; and
causing the agent to perform the selected action.

23. One or more non-transitory computer-readable storage media storing instructions that when executed by one or more computers cause the one or more computers to perform operations comprising:
receiving a task description, wherein the task description is a natural language description of a task to be performed by an agent in an environment; and
controlling the agent across a sequence of time steps to cause the agent to perform the task, comprising, at each of a plurality of time steps in the sequence:
obtaining a first observation characterizing a state of the environment at the time step;
processing a reporter input comprising the first observation using a reporter neural network to generate a reporter output that defines a natural language report that characterizes a progress of the agent in completing the task as of the time step;
processing a planner input that comprises the task description and the natural language report using a planner neural network to generate a natural language instruction for the agent;
obtaining a second observation characterizing a state of the environment at the time step;
processing the natural language instruction and the second observation using a policy neural network to generate a policy output that defines an action to be performed by the agent;
selecting an action using the policy output; and
causing the agent to perform the selected action.
